(19) United States
(12) Patent Application Publication
(10) Pub. No.: US 2022/0222105 A1
(43) Pub. Date: Jul. 14, 2022

(54) CONTAINER PROVISIONING

(71) Applicants: Jeffrey Christopher Sedayao, San Jose, CA (US); Juan Pablo Munzo, Folsom, CA (US); Vinoth kumar Chandra Mohan, San Jose, CA (US); Promila Agarwal, Milpitas, CA (US); Dean Chu, Mountain View, CA (US); Eve M. Schooler, Portola Valley, CA (US); Kshitij Arun Doshi, Tempe, AZ (US)

(72) Inventors: Jeffrey Christopher Sedayao, San Jose, CA (US); Juan Pablo Munzo, Folsom, CA (US); Vinoth kumar Chandra Mohan, San Jose, CA (US); Promila Agarwal, Milpitas, CA (US); Dean Chu, Mountain View, CA (US); Eve M. Schooler, Portola Valley, CA (US); Kshitij Arun Doshi, Tempe, AZ (US)

(21) Appl. No.: 17/711,462

(22) Filed: Apr. 1, 2022

(51) Int. Cl. G06F 9/455; G06F 8/61

(52) U.S. Cl. CPC G06F 9/45558; G06F 2009/45595; G06F 2009/45562; G06F 8/63

(57) ABSTRACT

System and techniques for container provisioning are described herein. A request to instantiate a container image may be made. This request specifies a name for the container image where the name is created through a first defined generation process applied to contents of the container image. A container manifest may be received from a local copy of a distributed container directory. The container manifest includes a set of entries for container layer images of the container image. Here, the set of entries are named by a second defined generation process applied to respective container layer images. Then, container layer images may be retrieved using names from the set of entries and the container image instantiated using the retrieved container layer images.

### TECHNICAL FIELD

Embodiments described herein generally relate to distributed computing architecture and more specifically to container provisioning.

### BACKGROUND

Modern computing environments, such as cloud computing, distributed edge computing, etc. employ software execution environments on various hardware. Containers were developed to address environmental compatibility in these various hardware environments. A container is a standard unit of software that packages code and dependencies (e.g., libraries, runtimes, operating systems, etc.). This packaging, also called a container image, enables hosting hardware to run an application quickly and reliably. Because everything is in the container image, the application runs in the same way from one computing environment to another. That is, a container image may be considered a lightweight, standalone, executable package of software that includes everything needed to run an application, including: code, runtime, system tools, system libraries, and settings. These elements may be referred to as container layers, packaged together-often with a manifest or other directory of container contents-into the container image. Thus, a container image may include an operating system layer, a runtime layer, a library layer, and an application layer, along with a manifest including details about the various layers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for container provisioning, according to an embodiment.

FIG. 2 illustrates an example to generate container components for distribution, according to an embodiment.

FIG. 3 illustrates examples of distributing container images, according to an embodiment.

FIG. 4 illustrates an example of provisioning containers, according to an embodiment.

FIG. 5 illustrates a flow diagram of an example of a method for container provisioning, according to an embodiment.

FIG. 6 is a schematic diagram of an example infrastructure processing unit (IPU), according to an embodiment.

FIG. 7 illustrates an example information centric network (ICN), according to an embodiment.

FIG. 8 is a block diagram illustrating an example of a machine upon which one or more embodiments may be implemented.

### DETAILED DESCRIPTION

Distributing containers, as may occur in cloud, datacenter, edge, or fog deployments, generally involves downloading container images to the execution platform. Downloading increasingly large container images from a container registry (e.g., repository) may be time-consuming (on the order of tens of minutes). Thus, retrieving container images may constitute a significant portion, and even the majority, of time to provision and execute a container. Other considerations may include the network path between a host to which the container is to be deployed and the registry where the container image resides. Such network paths may be or become highly constrained or unreliable. The often strained network resources of edge computing scenarios may exacerbate this issue.

Container engines may employ mechanisms to accelerate caching or downloading of container layers. However, these mechanisms are generally effective on a single host—e.g., by caching frequently used container layers at the host—and do not leverage nearby—from a network standpoint-hosts or other capable network nodes (e.g., network devices), such as infrastructure processing units (IPUs), Smart Switches, or the like. An example of these mechanisms is a union file system. The union file system enables pieces of a container image to be shared on the same real or virtual host. FastBuild is a system that speeds up the building of images through caching of layers. Container-First Virtualization enables compute nodes in a container engine cluster to use cluster elements as a registry before going externally to retrieve build layers. Other mechanisms for distributing and caching pieces of files have also been used, such as Information-Centric Networking (ICN), Peer to Peer (P2P) systems like BitTorrent, and Content Delivery Networks (CDN). Regarding enforcement of policies on who or what may download an image, image repositories services—such as Cloud Services Providers—may do employ basic restriction of access to images by users or sets of users, much like other web page or service endpoint accesses.

As noted above, these container engine caching mechanisms are generally designed to work within a single host. Thus, these mechanisms do not take advantage of container images pieces held by neighboring hosts. Although FastBuild leverages previous images used in building containers, FastBuild does not speed up the download of images from repositories nor does it leverage nearby hosts that may have some or all of a container needed. Container-First Virtualization may leverage nearby compute hosts if they are within a cluster (e.g., Docker Swarm or Kubernetes pod), but may not use other nearby hosts not in the same Swarm or pod and does not leverage other capable network nodes. Other caching systems and CDNs may be used to distribute individual build layers (e.g., container image layers) but are not integrated into container engines. Further, a user-based image access control used with public repositories or Cloud Services Providers generally works only if user capabilities and roles are correctly defined. However, even with correct user and role definitions, such repositories do not respect layer-specific elements, such as geographical restrictions. Accordingly, current systems and mechanisms address efficient use of container layers cached in a network, much less addressing layer constraints, such as a limited number of licenses for software used in images, regulatory constraints like privacy, or other business rules that an organization may place on container deployment.

To address the issues with current container image deployment and provisioning, information about the layered contents of container image may be embedded into a namespace that is usable by various caching or distribution mechanisms—such as CDNs, P2P distribution systems like BitTorrent, or ICN that are compatible with container layer naming practices. In an example, a directory uses that namespace to identify container images layers along with associated security, privacy, licenses, or other constraints. The namespace enables systems to request container layer images-abiding by existing constraints enabling accessible hosts (e.g., nearby hosts) or other capable network nodes to collaborate in provisioning containers. Because pull requests for build layer images are not limited to a centralized registry, a local cache, or a fellow host in the same cluster, hosts may obtain layers from neighboring hosts or other capable network nodes. This name-based caching and control enforcement approach is also well suited to decentralized P2P caching and access control in ICN.

Once container layer images may be obtained from other nodes and not just from a single repository, layers of a container may be obtained more quickly. Layers may also have constraints associated with their use, like privacy, geographic constraints, license limitations, or constraints regarding the use of encryption or other controlled technologies, enabling systematic mechanisms for enforcing these constraints. As the use of containers increases every month (estimated by some to be a compound annual growth rate (CAGR)>30%), the systems techniques described herein speed deployment of containers, improving application performance, while enabling users to systematically define and enforce constraints on how their software is used. Additional details and examples are provided below.

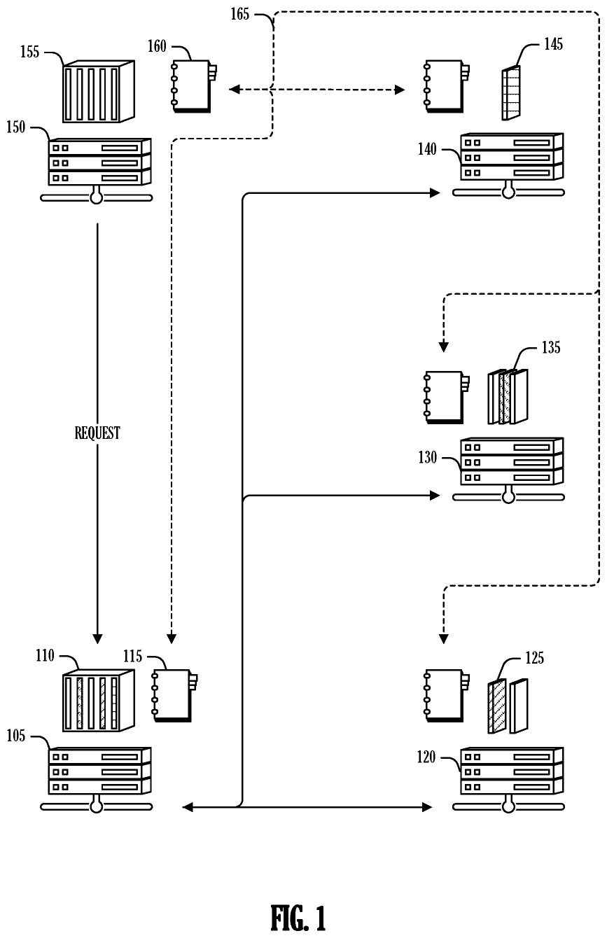

FIG. 1 is a block diagram of an example of an environment including a system for container provisioning, according to an embodiment. The various illustrated nodes—such as node 105, node 120, node 130, node 140, and node 150—include hardware (e.g., processors, accelerators, memory, non-volatile storage, etc.) that may be configured by software, to implement a variety of techniques. The following examples of container provisioning are illustrated from the perspective of the node 105. Here, processing circuitry on the node 105 is configured to receive a request to instantiate (e.g., creating an instance of, bring into being for any length of time, materialize, implement, etc.) the container image 110 from the node 150. The request specifies a name for the container image 110 that was created through a first defined generation process applied to contents of the container image 110. In an example, the first defined generation process is a hash of the container manifest. Generating the container image name by the first defined generation process operates to avoid confusion between nodes as to which container is being referenced. Thus, if two independent parties create the same container image, the container image will have the same name given the first defined generation process. Hashing all or certain elements of the container image contents is a technique to produce such a name generation. Accordingly, the entirety of the container image 110 may be hashed to produce the name. In an example, the manifest alone is hashed to produce the container image 110 name. As noted below, an example implementation embeds layer constraints in the manifest. Hashing the manifest thus produces a different container image name when layer constraints vary even if all of the layers are the same between two containers.

The processing circuitry of the node 105 is configured to obtain a container manifest from a local copy of a distributed container directory (DCD-LC) 115. As illustrated, the DCD 160 may be distributed on distribution path 165 to the various nodes 105, 120, 130, and 140 to provide DCD-LCs such as the DCD-LC 115. In the illustrated scenario, the request does not include the container manifest. Rather, the request simply uses the container name produced by the first defined generation process. This provides for efficient network use in making the request given the DCD-LC 115. However, in an example where the DCD-LC 115 is unavailable, out-of-date, or unreliable, in an example, the request may include the manifest.

The container manifest includes a set of entries for container layer images of the container image 110. Members of the set of entries are named by a second defined generation process applied to respective container layer images. In an example, the second defined generation process is a hash of a container layer image. Like the naming of the container image, by using the second generation process to create layer names based on the content of the layer means that independently created layers will have the same name when they are equivalent in the contents used for the name. Thus, the hash, or other generation technique, may operate on a software type, version, distributor, etc. In an example, the entire contents of the layer are hashed to produce the container name. This ensures that two layers with the same name are identical.

The processing circuitry of the node 105 is configured to obtain container layer images using names from the set of entries—the layer names for the container 110. If the container layers are cached locally in the node 105, the processing circuitry may use the cached versions. However, as illustrated, the shaded layers in the container 110 are not locally available. In these examples, the processing circuitry is configured to request the container layer by name from other nodes. As illustrated, the node 105 requests the container layer 145 from node 140, the container layer 135 from node 130, and the container layer 125 from node 120. In an example, the processing circuitry is configured to retrieving a first container layer image 125 from a first machine (e.g., node 120) that has cached the first container layer image 125 and retrieving a second container layer image 135 from a second machine (e.g., node 150) that generated the second container layer image. This example is illustrating that the first machine includes a cached version of a container layer image while the second machine is a repository from which the container layer image was originally produced. By using the techniques described herein, a hybrid of traditional container layer image delivery and distributed caching may be used. In an example, the first machine and the second machine not coordinating delivery of the first container layer image and the second container layer image. This example illustrates that, because of the name generation (e.g., by the second defined generation process), no coordination need occur between the node 150 (e.g., generating container layer images) and the node 120 (e.g., caching container layer images generated by the node 150). Rather, the container layer images may simply be dispersed throughout available caching nodes and requested when needed. Such an arrangement is especially natural for content networks, such as ICNs or CDNs.

Once the container layer images are obtained at the node 105, the processing circuitry of the node 105 is configured to instantiate the container image 110. Once the container image 110 is whole, the container may be run on the node 105 to provide application execution, completing the request of the node 150.

The following examples following the creation of a container image 155, including a container manifest that is included in a DCD 160 by processing circuitry of the node 150. Here, the node 150 may create or receive a container layer image for the container 155. The node 150 generates the container layer name from the container layer image 155 using the second defined generation process. Again, the contents of the container layer image 155 may be hashed, provided as input to an artificial neural network, or other deterministic generation process, to produce the name.

In an example, a container definition including identification of the container layer image—may be received or created along with the container layer. The container definition may be the container manifest, or may produce the container manifest (e.g., when compiled). The container manifest includes a list of container layers that make up the container 155. Thus, the container manifest includes the set of entries for the container layer images including the container layer image. In an example, the container manifest name (e.g., the name of the container 155) is based on the first defined generation process applied to the contents of the container manifest.

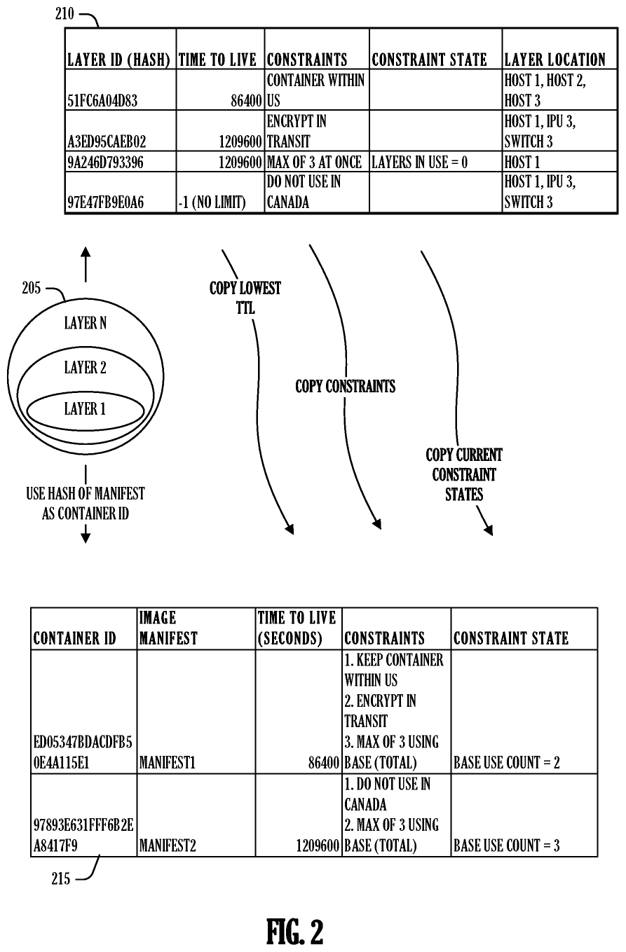

In an example, the container layer image includes a set of constraints. These constraints may include constraints on where (e.g., geographically), when, by whom, or by what, the container layer may be executed. In an example, the set of constraints are stored in an entry in the set of entries for the container layer image. FIG. 2 illustrates an example of constraints in such an entry. In an example, creating the container manifest includes storing constraints from the set of entries as a second set of constraints for the container image. Again, FIG. 2 illustrates an example of this. Because constraints may have conflicts—e.g., overlap or have incompatible directives-more restrictive constraints take precedence over less constrictive constraints, for example. Thus, if a first layer has a constraint that it must execute in North America, and a second layer has a constraint that it must execute in the United States of America (U.S.), the manifest includes the constraint that the container 155 is limited to execution in the U.S.

In an example, the constraints are governed by the provider of a given container layer. Thus, for example, when the node 105 requests the layer 145 from the node 140, the node 140 reads the constraints for the layer 145 from the DCD-LC. The node 140 then checks whether the request from the node 105 complies with those constraints. If the request does comply, then the container layer image 145 is provided to the node 105. Otherwise, the request is denied. For example, if the constraint requires execution in North America, and the node 105 is located in Ghana, the request will be denied. This mechanism operates as an access control technique with customizable sophistication that is easily distributed along with container layer images to uncoordinated caching nodes.

In an example, time-to-live (TTL) is a constraint. In an example, a smallest TTL of the container layer images is used as a container TTL recorded in the second set of constraints for the container manifest. In an example, retrieving the container layer images includes determining that the TTL of the container manifest has not expired. The TTL enables the producer of the container 155 to control how long, for example, caching nodes such as the node 140, serve a container layer. Thus, even without tracking where cached versions of a layer reside, or attempting to recall a container layer from a node, the producer controls how long the container layer is available before a refresh (e.g., reauthorization) occurs. Even if the container layer image does not change, this technique enables the producer to update the constraints, for example, should other circumstances change. In general, when the TTL is expired, the node 105, or the node 140, will re-request the container layer node from the producer (e.g., the node 150).

In an example, the set of constraints include a geographical constraint, a hardware constraint, or a processing constraint. The geographical constraint limits where a given layer may be executed. The hardware constraint addresses the type of equipment (e.g., an accelerator, certified hardware, a trusted computing base, etc.) upon which the layer may be executed. In an example, the processing constraint is an encryption requirement or a maximum number of instances limit.

As noted above, in an example, the container manifest for the container image is stored in the container directory 160. Then, the container directory may be distributed (the distribution path 165). In an example, an update to the DCD-LC 115 may be requested by the node 105 based on a trigger condition. The trigger condition may be an elapsed time since the last update or may include denial of a container layer image request because of an expired TTL.

These techniques provide a number of benefits. For example, using the defined generation processes for naming container deployments enables seamless use of multiple content distribution systems, such as CDNs, P2P systems like BitTorrent, or ICN. Also, a directory (e.g., catalog) of container build images using the generated names provides an efficient way to transfer the container information without having to transfer the entire container image (e.g., including the container layer images). Together, these accelerate container provisioning. Further, using constraints that follow container layers and are managed by container layer providers (e.g., cache nodes) provides a flexible and efficient access control of the container layer material.

FIG. 2 illustrates an example to generate container components for distribution, according to an embodiment. As illustrated the container 205 includes several layers. For these layers, a manifest 210 includes the layer names (e.g., layer identification (ID)), TTL, and constraints. Also illustrated in the manifest 210 are optional fields of constraint state and layer location. The layer location may help a node to find copies of the layers. The constraint state operates to maintain state variables of a constraint when it matters. The illustrated example of a maximum number of instances constraint involves tracking in-use instances in order to determine whether the maximum is reached.

The DCD 215 includes several containers. Note that the entries in the DCD include the constraints of the included layers. As noted above, in an example, where constraints of layers in a single container conflict, the container adopts the more restrictive constraint (or an intersection of constraints). When the optional constraint state is used, the state is maintained in the DCD entry. Thus, distributing the DCD enables any receiving node to manage the constraints for containers as when as layers.

In an example, the manifest is populated when containers not already in the DCD are built. The manifest uses the Layer ID to identify a container layer, for example, based on a digest of the layer. The DCD entry uses the Container ID as a name, which, for example, is a digest of the manifest of the layers. Using digests provides some benefit over using software names (e.g., assigned names) because such names may change between authors or over time.

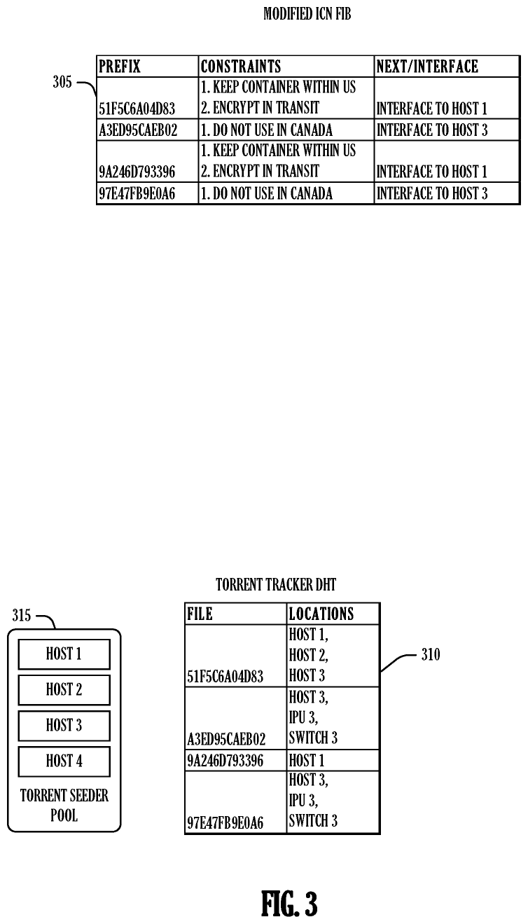

As illustrated, the constraints and the state of those constraints (e.g., maximum number of uses and the number of current uses) on the use of layers are tracked as well as a container TTL. When container images are built, the constraints of all the layers are associated with that particular image. At the same time, the lowest TTL for all of the layers is assigned to the container 205. In an example, downloads of the container images are done through content distribution mechanisms, such as ICN or BitTorrent. FIG. 3 illustrates examples of using ICN and BitTorrent in this manner.

The illustrated elements may be built in the following manner when, for example, a container image is not available in a host and is not in the DCD. First, information about each build layer of the container is also built. A layer ID may be created out of a software name and version and constraint information on the layer and host location may also be included. In an example, the creating the building the layer may add itself to the list of locations of that layer if the layer already exists. Data from the manifest 210 may then be used to form container names that contain information about the software versions inside of it. These may then be used to populate the DCD entry with constraint information. Together the manifest and the DCD entry form a catalog. Once the DCD 215 is created, a content distribution mechanism may be used to retrieve manifests and obtain build layer images on demand subject to the constraints. In an example, when a container is instantiated in this manner, the DCD-LC is updated with the container ID, manifest, and TTL.

FIG. 3 illustrates examples of distributing container images, according to an embodiment. Here, an ICN Forwarding Information Base (FIB) 305 includes field modifications not found in traditional ICN FIBs. Specifically, the FIB includes the additional constraints field. Thus, when an interest for the container layer image (identified by the illustrated name prefix field), the ICN router may check the constraints prior to forwarding the interest. This prevents unnecessary network traffic when the interest cannot be satisfied based on the constraints. Similar constraint checking may be performed prior to reaching the FIB when an ICN node determines whether it may satisfy the interest packet from its local cache.

Also illustrated is a BitTorrent tracker distributed hash table (DHT) 310 and a torrent seeder pool 315. Here, the seeder pool 315 directs clients (e.g., the node 105 from FIG. 1) to hosts that have the DHT 310. Once the DHT 310 is obtained, the client may identify which locations includes the container layer and request the container layer from that location. In this scenario, constraint compliance may be governed by the location when the request is made. The application of the DCD entries, or manifest entries, into the FIB 305 or the DHT 310, may be an additional process implemented in the distribution path 165 illustrated in FIG. 1.

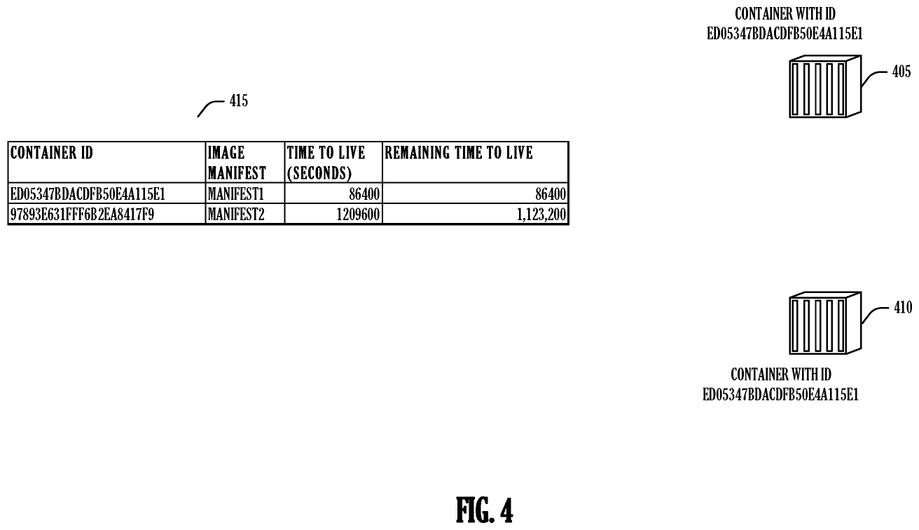

FIG. 4 illustrates an example of provisioning containers, according to an embodiment. On each host that has containers (e.g., the container 405 and the container 410), a container constraint management system keeps track of TTL in the DCD-LC 415. When a container's TTL goes to zero, the constraint management system checks the DCD 415 for the constraints and constraint state for the container image, and if the container may continue to be used, the container TTL is reset to the value in the DCD 415. With these mechanisms, the DCD 415 may be used to enforce licensing mechanisms—e.g., enforcing the number of simultaneous usages of a container layer—as well as respond to policy changes, such as privacy requirements for geographically constrained storage and processing of data.

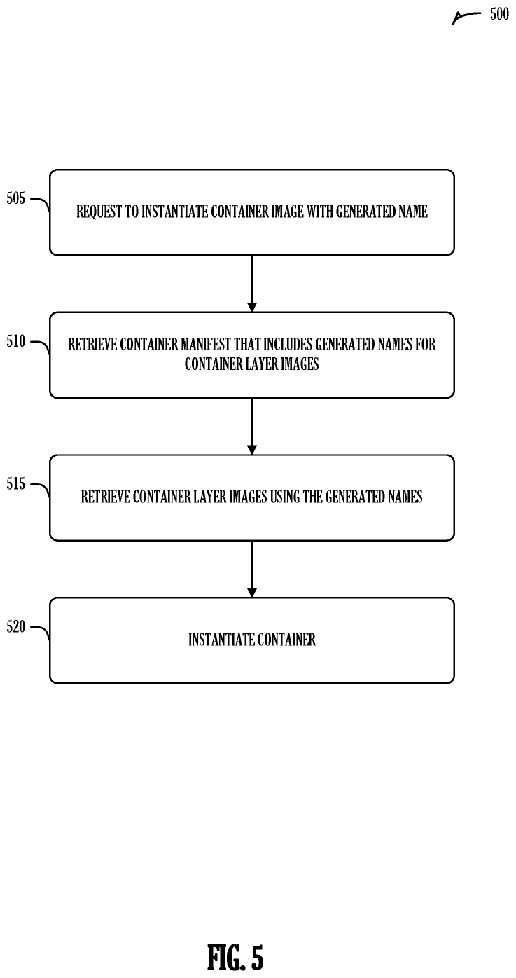

FIG. 5 illustrates a flow diagram of an example of a method 500 for container provisioning, according to an embodiment. The operations of the method 500 are performed on computer hardware, such as that described above or below (e.g., processing circuitry).

At operation 505, a request to instantiate a container image is obtained (e.g., retrieved or received). Here, the request specifies a name for the container image created through a first defined generation process applied to contents of the container image. In an example, the first defined generation process is a hash of the container manifest.

At operation 510, a container manifest is obtained from a local copy of a distributed container directory. Here, the container manifest includes a set of entries for container layer images of the container image. Members of the set of entries are named by a second defined generation process applied to respective container layer images. In an example, the second defined generation process is a hash of a container layer image.

At operation 515, container layer images are obtained using names from the set of entries. In an example, using names from the set of entries to obtain the container layer images includes retrieving a first container layer image from a first machine that has cached the first container layer image and retrieving a second container layer image from a second machine that generated the second container layer image. In an example, the first machine and the second machine not coordinating delivery of the first container layer image and the second container layer image.

At operation 520, the container image is instantiated using the container layer images that are retrieved.

In an example, the method 500 may include the following operations to create a container manifest. A container layer image is received. A container layer name is generated from the container layer image using the second defined generation process. A container definition-including identification of the container layer image—may be received. Then, the container manifest is created for the container image. Here, the container manifest includes the set of entries for the container layer images including the container layer image. Also, the container manifest name is based on the first defined generation process applied to the contents of the container manifest.

In an example, the container layer image includes a set of constraints. In an example, the set of constraints are stored in an entry in the set of entries for the container layer image. In an example, creating the container manifest includes storing constraints from the set of entries as a second set of constraints for the container image. Here, more restrictive constraints take precedence over less constrictive constraints, for example, when there is a conflict between the constraints.

In an example, time-to-live (TTL) is a constraint. In an example, a smallest TTL of the container layer images is used as a container TTL recorded in the second set of constraints for the container manifest. In an example, retrieving the container layer images includes determining that the TTL of the container manifest has not expired.

In an example, the set of constraints include a geographical constraint, a hardware constraint, or a processing constraint. In an example, the processing constraint is an encryption requirement or a maximum number of instances limit.

In an example, the container manifest for the container image is stored in a container directory. Then, the container directory may be distributed. In an example, an update to the local copy of the distributed container directory may be requested based on a trigger condition. The local copy of the distributed container directory may then be updated based on a response to requesting the update to the local copy of the distributed container directory.

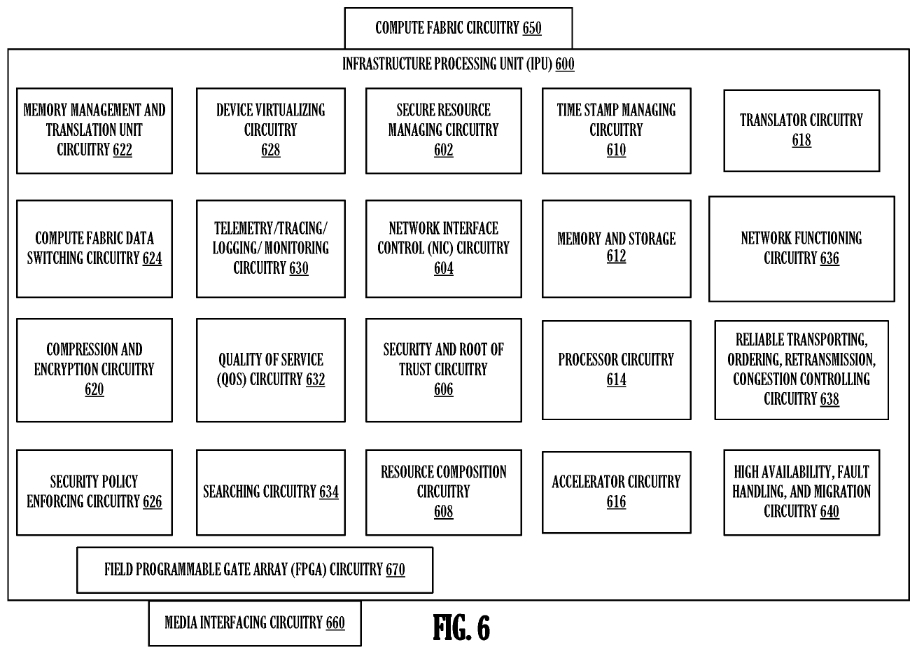

FIG. 6 depicts an example of an infrastructure processing unit (IPU). Different examples of IPUs disclosed herein enable improved performance, management, security and coordination functions between entities (e.g., cloud service providers), and enable infrastructure offload or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein may perform an application including any number of microservices, where each microservice runs in its own process and communicates using protocols (e.g., an HTTP resource API, message service or gRPC). Microservices may be independently deployed using centralized management of these services. A management system may be written in different programming languages and use different data storage technologies.

Furthermore, one or more IPUs may execute platform management, networking stack processing operations, security (crypto) operations, storage software, identity and key management, telemetry, logging, monitoring and service mesh (e.g., control how different microservices communicate with one another). The IPU may access an xPU to offload performance of various tasks. For instance, an IPU exposes XPU, storage, memory, and CPU resources and capabilities as a service that may be accessed by other microservices for function composition. This may improve performance and reduce data movement and latency. An IPU may perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 6, the IPU 600 includes or otherwise accesses secure resource managing circuitry 602, network interface controller (NIC) circuitry 604, security and root of trust circuitry 606, resource composition circuitry 608, time stamp managing circuitry 610, memory and storage 612, processing circuitry 614, accelerator circuitry 616, or translator circuitry 618. Any number or combination of other structure(s) may be used such as but not limited to compression and encryption circuitry 620, memory management and translation unit circuitry 622, compute fabric data switching circuitry 624, security policy enforcing circuitry 626, device virtualizing circuitry 628, telemetry, tracing, logging and monitoring circuitry 630, quality of service circuitry 632, searching circuitry 634, network functioning circuitry (e.g., routing, firewall, load balancing, network address translating (NAT), etc.) 636, reliable transporting, ordering, retransmission, congestion controlling circuitry 638, and high availability, fault handling and migration circuitry 640 shown in FIG. 6. Different examples may use one or more structures (components) of the example IPU 600 together or separately. For example, compression and encryption circuitry 620 may be used as a separate service or chained as part of a data flow with vSwitch and packet encryption.

In some examples, IPU 600 includes a field programmable gate array (FPGA) 670 structured to receive commands from an CPU, XPU, or application via an API and perform commands/tasks on behalf of the CPU, including workload management and offload or accelerator operations. The illustrated example of FIG. 6 may include any number of FPGAs configured or otherwise structured to perform any operations of any IPU described herein.

Example compute fabric circuitry 650 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 660 provides connectivity to a remote smartNIC or another IPU or service via a network medium or fabric. This may be provided over any type of network media (e.g., wired or wireless) and using any protocol (e.g., Ethernet, InfiniBand, Fiber channel, ATM, to name a few).

In some examples, instead of the server/CPU being the primary component managing IPU 600, IPU 600 is a root of a system (e.g., rack of servers or data center) and manages compute resources (e.g., CPU, xPU, storage, memory, other IPUs, and so forth) in the IPU 600 and outside of the IPU 600. Different operations of an IPU are described below.

In some examples, the IPU 600 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 600 is selected to perform a workload, secure resource managing circuitry 602 offloads work to a CPU, xPU, or other device and the IPU 600 accelerates connectivity of distributed runtimes, reduce latency, CPU and increases reliability.

In some examples, secure resource managing circuitry 602 runs a service mesh to decide what resource is to execute workload, and provide for L7 (application layer) and remote procedure call (RPC) traffic to bypass kernel altogether so that a user space application may communicate directly with the example IPU 600 (e.g., IPU 600 and application may share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh may provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 600 dynamically selects itself to run a given workload (e.g., microservice) within a composable infrastructure including an IPU, xPU, CPU, storage, memory, and other devices in a node.

In some examples, communications transit through media interfacing circuitry 660 of the example IPU 600 through a NIC/smartNIC (for cross node communications) or loopback back to a local service on the same host. Communications through the example media interfacing circuitry 660 of the example IPU 600 to another IPU may then use shared memory support transport between xPUs switched through the local IPUs. Use of IPU-to-IPU communication may reduce latency and jitter through ingress scheduling of messages and work processing based on service level objective (SLO).

For example, for a request to a database application that requires a response, the example IPU 600 prioritizes its processing to minimize the stalling of the requesting application. In some examples, the IPU 600 schedules the prioritized message request issuing the event to execute a SQL query database and the example IPU constructs microservices that issue SQL queries and the queries are sent to the appropriate devices or services.

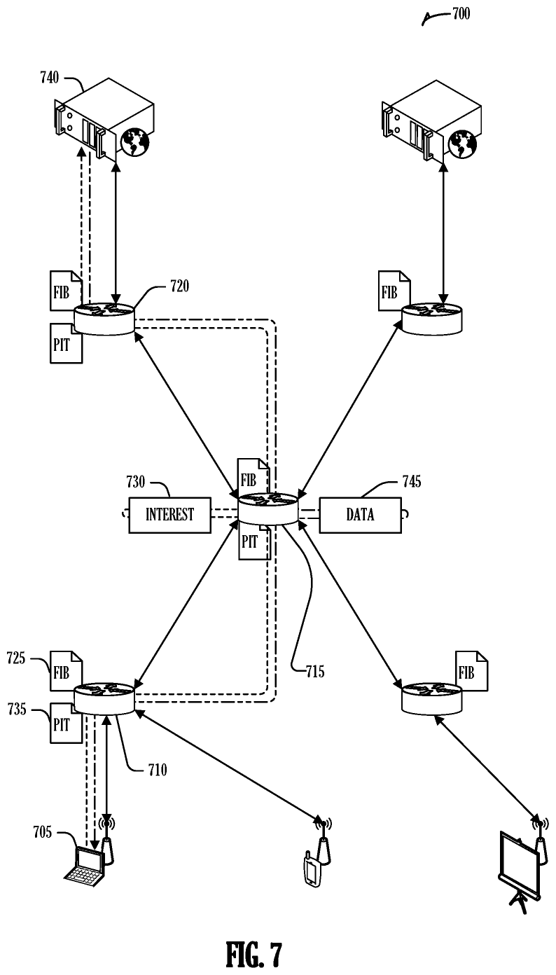

FIG. 7 illustrates an example information centric network (ICN), according to an embodiment. ICNs operate differently than traditional host-based (e.g., address-based) communication networks. ICN is an umbrella term for a networking paradigm in which information and/or functions themselves are named and requested from the network instead of hosts (e.g., machines that provide information). In a host-based networking paradigm, such as used in the Internet protocol (IP), a device locates a host and requests content from the host. The network understands how to route (e.g., direct) packets based on the address specified in the packet. In contrast, ICN does not include a request for a particular machine and does not use addresses. Instead, to get content, a device 705 (e.g., subscriber) requests named content from the network itself. The content request may be called an interest and transmitted via an interest packet 730. As the interest packet traverses network devices (e.g., network elements, routers, switches, hubs, etc.)—such as network elements 710, 715, and 720-a record of the interest is kept, for example, in a pending interest table (PIT) at each network element. Thus, network element 710 maintains an entry in its PIT 735 for the interest packet 730, network element 715 maintains the entry in its PIT, and network element 720 maintains the entry in its PIT.

When a device, such as publisher 740, that has content matching the name in the interest packet 730 is encountered, that device 740 may send a data packet 745 in response to the interest packet 730. Typically, the data packet 745 is tracked back through the network to the source (e.g., device 705) by following the traces of the interest packet 730 left in the network element PITs. Thus, the PIT 735 at each network element establishes a trail back to the subscriber 705 for the data packet 745 to follow.

Matching the named data in an ICN may follow several strategies. Generally, the data is named hierarchically, such as with a universal resource identifier (URI). For example, a video may be named www.somedomain.com or videos or v8675309. Here, the hierarchy may be seen as the publisher, “www.somedomain.com,” a sub-category, “videos,” and the canonical identification “v8675309.” As an interest 730 traverses the ICN, ICN network elements will generally attempt to match the name to a greatest degree. Thus, if an ICN element has a cached item or route for both “www.somedomain.com or videos” and “www.somedomain.com or videos or v8675309,” the ICN element will match the later for an interest packet 730 specifying “www.somedomain.com or videos or v8675309.” In an example, an expression may be used in matching by the ICN device. For example, the interest packet may specify “www.somedomain.com or videos or v8675*” where ‘*’ is a wildcard. Thus, any cached item or route that includes the data other than the wildcard will be matched.

Item matching involves matching the interest 730 to data cached in the ICN element. Thus, for example, if the data 745 named in the interest 730 is cached in network element 715, then the network element 715 will return the data 745 to the subscriber 705 via the network element 710. However, if the data 745 is not cached at network element 715, the network element 715 routes the interest 730 on (e.g., to network element 720). To facilitate routing, the network elements may use a forwarding information base 725 (FIB) to match named data to an interface (e.g., physical port) for the route. Thus, the FIB 725 operates much like a routing table on a traditional network device.

In an example, additional meta-data may be attached to the interest packet 730, the cached data, or the route (e.g., in the FIB 725), to provide an additional level of matching. For example, the data name may be specified as “www.somedomain.com or videos or v8675309,” but also include a version number—or timestamp, time range, endorsement, etc. In this example, the interest packet 730 may specify the desired name, the version number, or the version range. The matching may then locate routes or cached data matching the name and perform the additional comparison of meta-data or the like to arrive at an ultimate decision as to whether data or a route matches the interest packet 730 for respectively responding to the interest packet 730 with the data packet 745 or forwarding the interest packet 730.

ICN has advantages over host-based networking because the data segments are individually named. This enables aggressive caching throughout the network as a network element may provide a data packet 730 in response to an interest 730 as easily as an original author 740. Accordingly, it is less likely that the same segment of the network will transmit duplicates of the same data requested by different devices.

Fine grained encryption is another feature of many ICN networks. A typical data packet 745 includes a name for the data that matches the name in the interest packet 730. Further, the data packet 745 includes the requested data and may include additional information to filter similarly named data (e.g., by creation time, expiration time, version, etc.). To address malicious entities providing false information under the same name, the data packet 745 may also encrypt its contents with a publisher key or provide a cryptographic hash of the data and the name. Thus, knowing the key (e.g., from a certificate of an expected publisher 740) enables the recipient to ascertain whether the data is from that publisher 740. This technique also facilitates the aggressive caching of the data packets 745 throughout the network because each data packet 745 is self-contained and secure. In contrast, many host-based networks rely on encrypting a connection between two hosts to secure communications. This may increase latencies while connections are being established and prevents data caching by hiding the data from the network elements.

Example ICN networks include content centric networking (CCN), as specified in the Internet Engineering Task Force (IETF) draft specifications for CCNx 0.x and CCN 1.x, and named data networking (NDN), as specified in the NDN technical report DND-0001.

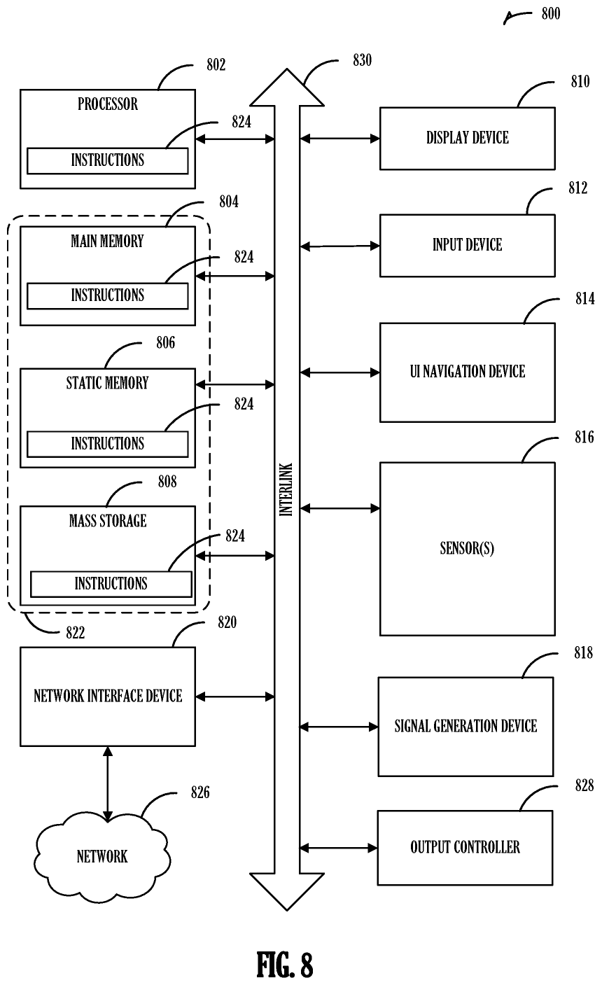

FIG. 8 illustrates a block diagram of an example machine 800 upon which any one or more of the techniques (e.g., methodologies) discussed herein may perform. Examples, as described herein, may include, or may operate by, logic or a number of components, or mechanisms in the machine 800. Circuitry (e.g., processing circuitry) is a collection of circuits implemented in tangible entities of the machine 800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 800 follow.

In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 800 may include a hardware processor 802 (e.g., a central processing unit (CPU), a graphics processing unit (GPU), a hardware processor core, or any combination thereof), a main memory 804, a static memory (e.g., memory or storage for firmware, microcode, a basic-input-output (BIOS), unified extensible firmware interface (UEFI), etc.) 806, and mass storage 808 (e.g., hard drives, tape drives, flash storage, or other block devices) some or all of which may communicate with each other via an interlink (e.g., bus) 830. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 808, a signal generation device 818 (e.g., a speaker), a network interface device 820, and one or more sensors 816, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 802, the main memory 804, the static memory 806, or the mass storage 808 may be, or include, a machine readable medium 822 on which is stored one or more sets of data structures or instructions 824 (e.g., software) embodying or utilized by any one or more of the techniques or functions described herein. The instructions 824 may also reside, completely or at least partially, within any of registers of the processor 802, the main memory 804, the static memory 806, or the mass storage 808 during execution thereof by the machine 800. In an example, one or any combination of the hardware processor 802, the main memory 804, the static memory 806, or the mass storage 808 may constitute the machine readable media 822. While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 822 may be representative of the instructions 824, such as instructions 824 themselves or a format from which the instructions 824 may be derived. This format from which the instructions 824 may be derived may include source code, encoded instructions (e.g., in compressed or encrypted form), packaged instructions (e.g., split into multiple packages), or the like. The information representative of the instructions 824 in the machine readable medium 822 may be processed by processing circuitry into the instructions to implement any of the operations discussed herein. For example, deriving the instructions 824 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 824.

In an example, the derivation of the instructions 824 may include assembly, compilation, or interpretation of the information (e.g., by the processing circuitry) to create the instructions 824 from some intermediate or preprocessed format provided by the machine readable medium 822. The information, when provided in multiple parts, may be combined, unpacked, and modified to create the instructions 824. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 824 may be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software. A transmission medium is a machine readable medium.

### ADDITIONAL NOTES & EXAMPLES

Example 1 is a network node for container provisioning, the network node comprising: memory; and processing circuitry that, when in operation, is configured by instructions in the memory to: receive a request to instantiate a container image, the request specifying a name for the container image created through a first defined generation process applied to contents of the container image; retrieve a container manifest from a local copy of a distributed container directory, the container manifest including a set of entries for container layer images of the container image, each of the set of entries named by a second defined generation process applied to respective container layer images; retrieve container layer images using names from the set of entries; and instantiate the container image using the container layer images that are retrieved.

In Example 2, the subject matter of Example 1 includes, wherein, to retrieve the container layer images using names from the set of entries, the processing circuitry is configured to: retrieve a first container layer image from a first machine that has cached the first container layer image; and retrieve a second container layer image from a second machine that generated the second container layer image, the first machine and the second machine not coordinating delivery of the first container layer image and the second container layer image.

In Example 3, the subject matter of Examples 1-2 includes, wherein the instructions further configured the processing circuitry to: receive a container layer image; generate a container layer name from the container layer image using the second defined generation process; receive a container definition including identification of the container layer image; and create the container manifest for the container image, the container manifest including the set of entries for the container layer images including the container layer image, a container manifest name of the container manifest is based on the first defined generation process applied to the contents of the container manifest.

In Example 4, the subject matter of Example 3 includes, wherein the container layer image includes a set of constraints, and wherein the set of constraints are stored in an entry in the set of entries for the container layer image.

In Example 5, the subject matter of Example 4 includes, wherein, to create the container manifest, the processing circuitry is configured to store constraints from the set of entries as a second set of constraints for the container image, a more restrictive constraint taking precedence over a less constrictive constraint when there is a conflict.

In Example 6, the subject matter of Example 5 includes, wherein the constraints include time-to-live (TTL), wherein a smallest TTL of the container layer images is used as a container TTL recorded in the second set of constraints for the container manifest.

In Example 7, the subject matter of Example 6 includes, wherein, to retrieve the container layer images, the processing circuitry is configured to determine that the TTL of the container manifest has not expired.

In Example 8, the subject matter of Examples 4-7 includes, wherein the set of constraints includes a geographical constraint, a hardware constraint, or a processing constraint.

In Example 9, the subject matter of Example 8 includes, wherein the processing constraint is an encryption requirement or a maximum number of instances limit.

In Example 10, the subject matter of Examples 3-9 includes, wherein the instructions further configured the processing circuitry to: store the container manifest for the container image in a container directory; and distribute the container directory.

In Example 11, the subject matter of Example 10 includes, wherein the instructions further configured the processing circuitry to: request an update to the local copy of the distributed container directory based on a trigger condition; and update the local copy of the distributed container directory based on a response to requesting the update to the local copy of the distributed container directory.

In Example 12, the subject matter of Examples 1-11 includes, wherein the second defined generation process includes hashing a container layer image.

In Example 13, the subject matter of Examples 1-12 includes, wherein the first defined generation process is includes hashing the container manifest.

Example 14 is a method for container provisioning, the method comprising: receiving a request to instantiate a container image, the request specifying a name for the container image created through a first defined generation process applied to contents of the container image; retrieving a container manifest from a local copy of a distributed container directory, the container manifest including a set of entries for container layer images of the container image, each of the set of entries named by a second defined generation process applied to respective container layer images; retrieving container layer images using names from the set of entries; and instantiating the container image using the container layer images that are retrieved.

In Example 15, the subject matter of Example 14 includes, wherein retrieving container layer images using names from the set of entries includes: retrieving a first container layer image from a first machine that has cached the first container layer image; and retrieving a second container layer image from a second machine that generated the second container layer image, the first machine and the second machine not coordinating delivery of the first container layer image and the second container layer image.

In Example 16, the subject matter of Examples 14-15 includes, receiving a container layer image; generating a container layer name from the container layer image using the second defined generation process; receiving a container definition including identification of the container layer image; and creating the container manifest for the container image, the container manifest including the set of entries for the container layer images including the container layer image, a container manifest name of the container manifest is based on the first defined generation process applied to the contents of the container manifest.

In Example 17, the subject matter of Example 16 includes, wherein the container layer image includes a set of constraints, and wherein the set of constraints are stored in an entry in the set of entries for the container layer image.

In Example 18, the subject matter of Example 17 includes, wherein creating the container manifest includes storing constraints from the set of entries as a second set of constraints for the container image, a more restrictive constraint taking precedence over a less constrictive constraint when there is a conflict.

In Example 19, the subject matter of Example 18 includes, wherein the constraints include time-to-live (TTL), wherein a smallest TTL of the container layer images is used as a container TTL recorded in the second set of constraints for the container manifest.

In Example 20, the subject matter of Example 19 includes, wherein retrieving the container layer images includes determining that the TTL of the container manifest has not expired.

In Example 21, the subject matter of Examples 17-20 includes, wherein the set of constraints includes a geographical constraint, a hardware constraint, or a processing constraint.

In Example 22, the subject matter of Example 21 includes, wherein the processing constraint is an encryption requirement or a maximum number of instances limit.

In Example 23, the subject matter of Examples 16-22 includes, storing the container manifest for the container image in a container directory; and distributing the container directory.

In Example 24, the subject matter of Example 23 includes, requesting an update to the local copy of the distributed container directory based on a trigger condition; and updating the local copy of the distributed container directory based on a response to requesting the update to the local copy of the distributed container directory.

In Example 25, the subject matter of Examples 14-24 includes, wherein the second defined generation process includes hashing a container layer image.

In Example 26, the subject matter of Examples 14-25 includes, wherein the first defined generation process is includes hashing the container manifest.

Example 27 is a machine readable medium including instructions for container provisioning, the instructions, when executed by processing circuitry, cause the processing circuitry to perform operations comprising: receiving a request to instantiate a container image, the request specifying a name for the container image created through a first defined generation process applied to contents of the container image; retrieving a container manifest from a local copy of a distributed container directory, the container manifest including a set of entries for container layer images of the container image, each of the set of entries named by a second defined generation process applied to respective container layer images; retrieving container layer images using names from the set of entries; and instantiating the container image using the container layer images that are retrieved.

In Example 28, the subject matter of Example 27 includes, wherein retrieving container layer images using names from the set of entries includes: retrieving a first container layer image from a first machine that has cached the first container layer image; and retrieving a second container layer image from a second machine that generated the second container layer image, the first machine and the second machine not coordinating delivery of the first container layer image and the second container layer image.

In Example 29, the subject matter of Examples 27-28 includes, wherein the operations comprise: receiving a container layer image; generating a container layer name from the container layer image using the second defined generation process; receiving a container definition including identification of the container layer image; and creating the container manifest for the container image, the container manifest including the set of entries for the container layer images including the container layer image, a container manifest name of the container manifest is based on the first defined generation process applied to the contents of the container manifest.

In Example 30, the subject matter of Example 29 includes, wherein the container layer image includes a set of constraints, and wherein the set of constraints are stored in an entry in the set of entries for the container layer image.

In Example 31, the subject matter of Example 30 includes, wherein creating the container manifest includes storing constraints from the set of entries as a second set of constraints for the container image, a more restrictive constraint taking precedence over a less constrictive constraint when there is a conflict.

In Example 32, the subject matter of Example 31 includes, wherein the constraints include time-to-live (TTL), wherein a smallest TTL of the container layer images is used as a container TTL recorded in the second set of constraints for the container manifest.

In Example 33, the subject matter of Example 32 includes, wherein retrieving the container layer images includes determining that the TTL of the container manifest has not expired.

In Example 34, the subject matter of Examples 30-33 includes, wherein the set of constraints includes a geographical constraint, a hardware constraint, or a processing constraint.

In Example 35, the subject matter of Example 34 includes, wherein the processing constraint is an encryption requirement or a maximum number of instances limit.

In Example 36, the subject matter of Examples 29-35 includes, wherein the operations comprise: storing the container manifest for the container image in a container directory; and distributing the container directory.

In Example 37, the subject matter of Example 36 includes, wherein the operations comprise: requesting an update to the local copy of the distributed container directory based on a trigger condition; and updating the local copy of the distributed container directory based on a response to requesting the update to the local copy of the distributed container directory.

In Example 38, the subject matter of Examples 27-37 includes, wherein the second defined generation process includes hashing a container layer image.

In Example 39, the subject matter of Examples 27-38 includes, wherein the first defined generation process is includes hashing the container manifest.

Example 40 is a system for container provisioning, the system comprising: means for receiving a request to instantiate a container image, the request specifying a name for the container image created through a first defined generation process applied to contents of the container image; means for retrieving a container manifest from a local copy of a distributed container directory, the container manifest including a set of entries for container layer images of the container image, each of the set of entries named by a second defined generation process applied to respective container layer images; means for retrieving container layer images using names from the set of entries; and means for instantiating the container image using the container layer images that are retrieved.

In Example 41, the subject matter of Example 40 includes, wherein the means for retrieving container layer images using names from the set of entries include: means for retrieving a first container layer image from a first machine that has cached the first container layer image; and means for retrieving a second container layer image from a second machine that generated the second container layer image, the first machine and the second machine not coordinating delivery of the first container layer image and the second container layer image.

In Example 42, the subject matter of Examples 40-41 includes, means for receiving a container layer image; means for generating a container layer name from the container layer image using the second defined generation process; means for receiving a container definition including identification of the container layer image; and means for creating the container manifest for the container image, the container manifest including the set of entries for the container layer images including the container layer image, a container manifest name of the container manifest is based on the first defined generation process applied to the contents of the container manifest.

In Example 43, the subject matter of Example 42 includes, wherein the container layer image includes a set of constraints, and wherein the set of constraints are stored in an entry in the set of entries for the container layer image.

In Example 44, the subject matter of Example 43 includes, wherein the means for creating the container manifest include means for storing constraints from the set of entries as a second set of constraints for the container image, a more restrictive constraint taking precedence over a less constrictive constraint when there is a conflict.

In Example 45, the subject matter of Example 44 includes, wherein the constraints include time-to-live (TTL), wherein a smallest TTL of the container layer images is used as a container TTL recorded in the second set of constraints for the container manifest.

In Example 46, the subject matter of Example 45 includes, wherein the means for retrieving the container layer images include means for determining that the TTL of the container manifest has not expired.

In Example 47, the subject matter of Examples 43-46 includes, wherein the set of constraints includes a geographical constraint, a hardware constraint, or a processing constraint.

In Example 48, the subject matter of Example 47 includes, wherein the means for processing constraint is an encryption requirement or a maximum number of instances limit.

In Example 49, the subject matter of Examples 42-48 includes, means for storing the container manifest for the container image in a container directory; and means for distributing the container directory.

In Example 50, the subject matter of Example 49 includes, means for requesting an update to the local copy of the distributed container directory based on a trigger condition; and means for updating the local copy of the distributed container directory based on a response to requesting the update to the local copy of the distributed container directory.

In Example 51, the subject matter of Examples 40-50 includes, wherein the second defined generation process includes hashing a container layer image.

In Example 52, the subject matter of Examples 40-51 includes, wherein the first defined generation process is includes hashing the container manifest.

Example 53 is at least one machine-readable medium including instructions that, when executed by processing circuitry, cause the processing circuitry to perform operations to implement of any of Examples 1-52.

Example 54 is an apparatus comprising means to implement of any of Examples 1-52.

Example 55 is a system to implement of any of Examples 1-52.

Example 56 is a method to implement of any of Examples 1-52.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A network node for container provisioning, the network node comprising:
memory; and
processing circuitry that, when in operation, is configured by instructions in the memory to:
receive a request to instantiate a container image, the request specifying a name for the container image created through a first defined generation process applied to contents of the container image;
retrieve a container manifest from a local copy of a distributed container directory, the container manifest including a set of entries for container layer images of the container image, each of the set of entries named by a second defined generation process applied to respective container layer images;
retrieve container layer images using names from the set of entries; and
instantiate the container image using the container layer images that are retrieved.

2. The network node of claim 1, wherein, to retrieve the container layer images using names from the set of entries, the processing circuitry is configured to:
retrieve a first container layer image from a first machine that has cached the first container layer image; and
retrieve a second container layer image from a second machine that generated the second container layer image, the first machine and the second machine not coordinating delivery of the first container layer image and the second container layer image.

3. The network node of claim 1, wherein the instructions further configured the processing circuitry to:
receive a container layer image;
generate a container layer name from the container layer image using the second defined generation process;
receive a container definition including identification of the container layer image; and
create the container manifest for the container image, the container manifest including the set of entries for the container layer images including the container layer image, a container manifest name of the container manifest is based on the first defined generation process applied to the contents of the container manifest.

4. The network node of claim 3, wherein the container layer image includes a set of constraints, and wherein the set of constraints are stored in an entry in the set of entries for the container layer image.

5. The network node of claim 4, wherein, to create the container manifest, the processing circuitry is configured to store constraints from the set of entries as a second set of constraints for the container image, a more restrictive constraint taking precedence over a less constrictive constraint when there is a conflict.

6. The network node of claim 4, wherein the set of constraints includes a geographical constraint, a hardware constraint, or a processing constraint.

7. The network node of claim 3, wherein the instructions further configured the processing circuitry to:
store the container manifest for the container image in a container directory; and
distribute the container directory.

8. The network node of claim 1, wherein the first defined generation process is includes hashing the container manifest.

9. A method for container provisioning, the method comprising:
receiving a request to instantiate a container image, the request specifying a name for the container image created through a first defined generation process applied to contents of the container image;
retrieving a container manifest from a local copy of a distributed container directory, the container manifest including a set of entries for container layer images of the container image, each of the set of entries named by a second defined generation process applied to respective container layer images;
retrieving container layer images using names from the set of entries; and
instantiating the container image using the container layer images that are retrieved.

10. The method of claim 9, wherein retrieving container layer images using names from the set of entries includes:
retrieving a first container layer image from a first machine that has cached the first container layer image; and
retrieving a second container layer image from a second machine that generated the second container layer image, the first machine and the second machine not coordinating delivery of the first container layer image and the second container layer image.

11. The method of claim 9, comprising:
receiving a container layer image;
generating a container layer name from the container layer image using the second defined generation process;
receiving a container definition including identification of the container layer image; and
creating the container manifest for the container image, the container manifest including the set of entries for the container layer images including the container layer image, a container manifest name of the container manifest is based on the first defined generation process applied to the contents of the container manifest.

12. The method of claim 11, wherein the container layer image includes a set of constraints, and wherein the set of constraints are stored in an entry in the set of entries for the container layer image.

13. The method of claim 12, wherein creating the container manifest includes storing constraints from the set of entries as a second set of constraints for the container image, a more restrictive constraint taking precedence over a less constrictive constraint when there is a conflict.

14. The method of claim 12, wherein the set of constraints includes a geographical constraint, a hardware constraint, or a processing constraint.

15. The method of claim 11, comprising:
storing the container manifest for the container image in a container directory; and
distributing the container directory.

16. The method of claim 9, wherein the first defined generation process is includes hashing the container manifest.

17. A non-transitory machine readable medium including instructions for container provisioning, the instructions, when executed by processing circuitry, cause the processing circuitry to perform operations comprising:
receiving a request to instantiate a container image, the request specifying a name for the container image created through a first defined generation process applied to contents of the container image;
retrieving a container manifest from a local copy of a distributed container directory, the container manifest including a set of entries for container layer images of the container image, each of the set of entries named by a second defined generation process applied to respective container layer images;
retrieving container layer images using names from the set of entries; and
instantiating the container image using the container layer images that are retrieved.

18. The non-transitory machine readable medium of claim 17, wherein retrieving container layer images using names from the set of entries includes:
retrieving a first container layer image from a first machine that has cached the first container layer image; and
retrieving a second container layer image from a second machine that generated the second container layer image, the first machine and the second machine not coordinating delivery of the first container layer image and the second container layer image.

19. The non-transitory machine readable medium of claim 17, wherein the operations comprise:
receiving a container layer image;
generating a container layer name from the container layer image using the second defined generation process;
receiving a container definition including identification of the container layer image; and
creating the container manifest for the container image, the container manifest including the set of entries for the container layer images including the container layer image, a container manifest name of the container manifest is based on the first defined generation process applied to the contents of the container manifest.

20. The non-transitory machine readable medium of claim 19, wherein the container layer image includes a set of constraints, and wherein the set of constraints are stored in an entry in the set of entries for the container layer image.

21. The non-transitory machine readable medium of claim 20, wherein creating the container manifest includes storing constraints from the set of entries as a second set of constraints for the container image, a more restrictive constraint taking precedence over a less constrictive constraint when there is a conflict.

22. The non-transitory machine readable medium of claim 20, wherein the set of constraints includes a geographical constraint, a hardware constraint, or a processing constraint.

23. The non-transitory machine readable medium of claim 19, wherein the operations comprise:
storing the container manifest for the container image in a container directory; and
causing distribution of the container directory.

24. The non-transitory machine readable medium of claim 17, wherein the first defined generation process is includes hashing the container manifest.
